(19) United States
(12) Patent Application Publication
(10) Pub. No.: US 2014/0112147 A1
(43) Pub. Date: Apr. 24, 2014

(54) REFRESH MECHANISM FOR A TOKEN BUCKET

(71) Applicant: Broadcom Corporation, Irvine, CA (US)

(72) Inventor: THOMAS MICHAEL ESPOSITO, Andover, MA (US)

(73) Assignee: Broadcom Corporation, Irvine, CA (US)

(21) Appl. No.: 14/041,031

(22) Filed: Sep. 30, 2013

Related U.S. Application Data
(60) Provisional application No. 61/716,183, filed on Oct. 19, 2012.

(51) Int. Cl. H04L 12/819

(52) U.S. Cl. CPC H04L 47/215
USPC 370/235.1

(57) ABSTRACT

Embodiments of the present disclosure provide apparatuses, systems, and methods for accounting for tokens in one or more token buckets. One such embodiment includes memory; and a token bucket administration apparatus configured to iterate through a plurality of token buckets assigned to specific positions within a calendar segment and process each token bucket in sequence by reading a biased token count value from the memory for a token bucket, adjusting the biased token bucket value, and writing the adjusted token bucket value back to the memory.

### CROSS-REFERENCE TO RELATED APPLICATION

This application claims priority to copending U.S. provisional application entitled, “Refresh Mechanism for Token Bucket Meters,” having Ser. No. 61/716,183, filed Oct. 19, 2012, which is entirely incorporated herein by reference.

### BACKGROUND

In networks, it may be desirable to control or limit the amount of data which may flow through a particular switch or router. For example, a token bucket utilized by the switch may allow a certain amount of burstiness while imposing a limit on the average data transmission rate. However, maintaining a large number of token buckets (e.g., 1 million) by the switch is challenging.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a network processing device in accordance with embodiments of the present disclosure.

FIG. 2 is a block diagram showing an exemplary token bucket administration apparatus of the network processing device in accordance with embodiments of the present disclosure.

FIG. 3 is a flow chart diagram describing an exemplary process of accounting for tokens for a token bucket within an embodiment of a token bucket administration apparatus of the network processing device of FIG. 1.

FIG. 4 is a block diagram of an exemplary refresh calendar segment utilized by the token bucket administration apparatus of FIG. 1 in accordance with the present disclosure.

FIG. 5 is a flow chart diagram describing an exemplary periodic update process for plural token buckets within an embodiment of a flow controller of the network processing device of FIG. 1.

FIG. 6 is block diagram of an exemplary network processing device equipped with an embodiment of the token bucket administration apparatus according to the present disclosure.

### DETAILED DESCRIPTION

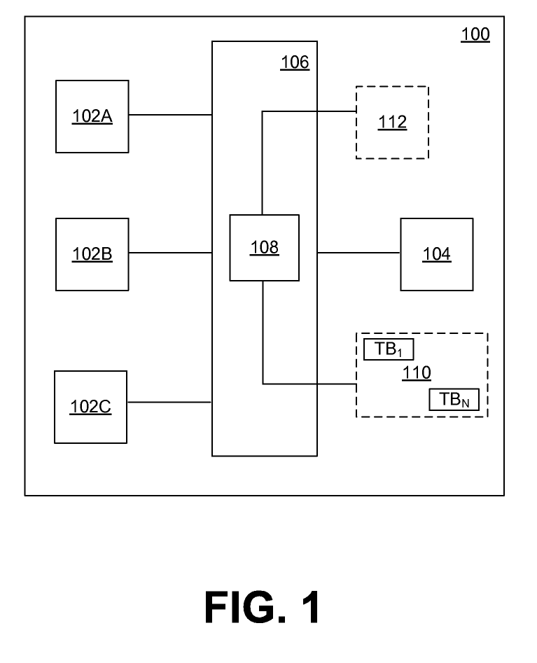

Embodiments of the present disclosure provide systems and methods for accounting for token levels in token bucket(s) utilized in network processing devices. FIG. 1 is a block diagram of a network processing device 100 according to an example embodiment. The network processing device 100 may, for example, be or include a router or switch configured to receive data. The data may be received in packets. The network processing device 100 may, for example, receive data from one or more sources, such as via an input port. While plural input ports 102A-C (e.g., three input ports) are included in the example shown in FIG. 1, any number of input ports may be included in the network processing device 100. The network processing device 100 may also send the data, either in the same packets as received or formatted into a different form, to one or more other network devices (not shown), such as through an output port. While one output port 104 is included in the example shown in FIG. 1, any number of output ports may be included in the network processing device 100. The network processing device 100 may, for example, multiplex the data through a single output port, or may route the data through a plurality of ports.

Turning to FIG. 1, the input ports 102 and one or more output ports 104 are coupled to a switching engine 106. The switching engine 106 comprises a token bucket administration apparatus 108, among other possible components. In an example embodiment, one or more network devices which receive data from the network processing device 100 may have a limited ability to handle and/or process data received from the network processing device 100. A network device may, for example, not be able to process data at the same rate at which the network processing device 100 receives and/or forwards data. It may be desirable for the network processing device 100 to control the rate at which data flows from the network processing device 100 to other network devices.

Therefore, the token bucket is used in packet switched computer networks to check and/or enforce that data transmissions conform to defined limits on bandwidth and/or burstiness. The token bucket is based on an analogy of a fixed capacity bucket into which tokens, normally representing a unit of bytes or a single packet of predetermined size, are added at a fixed token accumulation rate, as understood in the art.

When used for policing, the token count is checked upon arrival of a packet into the network processing device 100 in order to identify if the packet is in or out-of-profile. For example, in some systems a packet is in-profile if the token count is greater than or equal to the packet size and in other systems the packet is in-profile if the token count is merely greater than or equal to 0. If the packet is in-profile, a number of tokens equal to the size of the packet is subtracted from the token count.

When used for scheduling, the token count may be interpreted as a credit whose value is mapped to a selection priority, or may disqualify a queue for selection when below a threshold. When a packet is dequeued and transmitted, its length is subtracted from the associated token count. The present disclosure focuses on policing as a non-limiting example. However, the algorithm for maintaining the token count is also applicable to scheduling (e.g. creditor and/or shaper).

In implementing the token bucket, a token bucket status (TB₁ . . . TB_{N}) is maintained in memory 110 for each of the token buckets. In one embodiment, the token bucket administration apparatus 108 may be a hardware circuit that manages each of the stored token bucket statuses. Therefore, the token bucket administration apparatus 108 may read a token bucket status, such as a biased token count value, from memory 110, update the token bucket status based on a refresh operation and/or a newly received packet, and then write the value back into memory 110. After reading the value from memory, the “actual” token count is calculated by adding the token bias to the biased token count. After updating the token count (e.g. subtracting tokens equal to packet size), the inverse operation calculates the new biased token count to be stored in memory 110 by subtracting the token bias from the new token count.

In one embodiment, the token bucket administration apparatus 108 manages or administers update processes for all the token buckets in use. In accordance with embodiments of the present disclosure, the token bucket administration apparatus 108 tracks time between a current or newly received packet and a start of a periodic timing period, such as a refresh period. Therefore, time stamps as to arrival of previous packets are not needed to be stored or maintained with the token bucket status.

In one embodiment, to determine a current token count for a particular token bucket, the token bucket administration apparatus 108 may read the previously stored token bucket status, such as a biased token count value, from memory 110, and then add a number of tokens that could have been accumulated from the start of the timing period to the arrival of the packet (i.e., the token bias) in order to obtain the current token count. Based on whether the newly arrived packet is determined to be conforming or not conforming to network rules, tokens may be subtracted from the token count corresponding to the size of the packet. The new biased token count value stored back to memory 110 to represent the current status of the token bucket is the new token bucket count minus the number of tokens that could have been accumulated from the start of the timing period to the arrival of the packet (i.e., the token bias). Accordingly, the token bucket status refers to a status in general, where one of the elements of this status is the biased token count. The biased token count consists of the token count (TC) minus the token bias (TB) calculated at the time of the previous packet arrival.

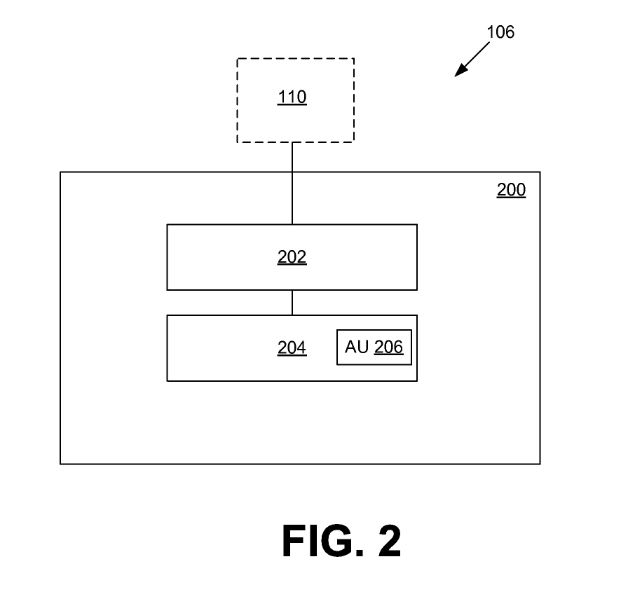

Referring to FIG. 2, the token bucket administration apparatus 108 is supported by hardware, for example an integrated circuit 200, providing a memory controller unit 202 coupled a processing resource, for example a control unit 204. The memory control unit 202 accesses the memory 110 for stored data concerning the types of packet that the network processing device 100 receives. The memory 110 further comprises constants and variables relating to profiles of flows. The number of profiles stored in memory 110 corresponds to the number of token buckets that are managed by the token bucket administration apparatus 108. The control unit 204 is coupled to a timer 112 and also comprises an arithmetic unit 206 and temporary registers (not shown). In one embodiment, the timer 112 comprises a 40 bit free running timer that increments on every clock cycle. It starts at 0 when the token bucket administration apparatus 108 transitions from disabled to enabled.

In general, the token bucket administration apparatus 108 implements a background process to refresh the tokens of the token buckets at a configured token accumulation rate R. Accordingly, in one embodiment, the token bucket administration apparatus 108 has a state machine that is responsible for generating background operation requests to perform these refreshes. In one exemplary implementation, the token bucket administration apparatus also has a 20-bit segment visit_interval register that defines the frequency of background operations for the token bucket administration apparatus 108. The background updates are requested such that each update refreshes the next token bucket in the sequence with visit_interval clock cycles between consecutive updates.

In operation, a packet is received at one of the input ports 102. In response to receipt of the packet, the control unit 204 interacts with the RAM memory control unit 202 in order to initiate parsing of the received packet in order to obtain frame information to determine a traffic flow associated with the received packet. For each traffic flow to which the network processing device 100 is required to recognize, the memory 110 stores associated token bucket data. In one embodiment, the associated token bucket data stored includes constants (for example a burst size BS, and a token accumulation rate R) or alternatively, a pointer indexing into a table of profiles, where each profile contains the constants. Also, a biased token count value corresponding to the fill status of the token bucket is recorded in memory 110. Alternatively, the biased token count value may be stored in a table similar to the table of profiles.

Embodiments of the present disclosure encode the rate value R in a normalized floating-point format. The token accumulation rate R (expressed in bytes per clock cycle) indicates the rate at which a particular token bucket accumulates tokens. In an exemplary (and non-limiting) implementation, the value is encoded in a normalized floating-point format having an 11-bit mantissa and a 5-bit exponent. The rate R can be multiplied by a time interval measured in clock cycles in order to calculate the number of tokens accumulated during that time interval (i.e., the token bias). This calculated value can be added to the biased token count to obtain the actual token count at a particular instant.

Note, the granularity of the token bucket may be generally 1 token per byte, but there are circumstances under which a single token represents a fraction of a byte (½, ¼, ⅛, etc.). In any case, the rate R may be generally expressed in bytes, regardless of the token granularity. Note further that other implementations can modify the format by changing the number of bits in the representation, or use an entirely different floating-point format.

When referencing the token bucket in order to query and/or update the token count (e.g., in response to a packet arrival), the control unit 202 receives the burst size BS, a rate R, and biased token count value (BTC), and in some embodiments, the length of the packet in bytes (L). This data is then used by the arithmetic unit 206 of the control unit 202 as follows in order to maintain one or more token bucket statuses.

Next, an exemplary process of allocating tokens is demonstrated using an embodiment of the present disclosure. For the example, the rate R for a token bucket accumulates tokens at a rate of 1 billion tokens per second. Assume at time t=0, the token bucket is full, where the maximum burst size is 1000. Then, at time t=1 millisecond, a first packet of length 1000 arrives for the token bucket. Therefore, at the time of arrival of the incoming packet, it has been 1 millisecond since time t=0. During this length of time, a million tokens would accumulate at a rate of 1 billion tokens/second. However, the token bucket is already at capacity (i.e., the stored biased token count value is 1000) so the addition of 1 billion tokens/second still leaves the token bucket at capacity or 1000 tokens due to the burst size of 1000 for the token bucket. Now, let's assume that the token bucket is in-profile and that corresponding token size of the packet is to be subtracted. Accordingly, the token count after the subtraction of 1000 tokens is 0. However, this is not the value to be written back to memory 110 by token bucket administration apparatus 108.

Instead, the following biased token count value is stored: current token count−token bias (TB), where TB=all tokens that could have accumulated between now (t=T₁=1 millisecond) and T₀ (t=0). In this example, time between T₀ and T₁ is 1 millisecond which equals to 1 million tokens. So, the value that is stored, as the biased token count value, is 0-1 million tokens=−1 million. In general, the token bias value at a particular instant is the elapsed time multiplied by the rate expressed in tokens per unit time.

Now, assume a second packet arrives 1 nanosecond later. Accordingly, time T₂=T₁+1 nanosecond=0.001000001 seconds, and the corresponding token bias is 1,000,001. In other words, at the time of arrival of the incoming packet, a million and one tokens would accumulate in accordance with an accumulation rate of 1 billion tokens/second. Therefore, to determine the current token count, the biased token count value stored in memory 110 is added to the token bias value calculated at T₂. Accordingly, current token count=−1,000,000+1,000,001=1.

For a first test case, assume the size or length of the second packet corresponds to 1000 tokens. Now, let's assume that the token bucket is out-of-profile (because in-profile requires that the token count be >=the packet length) and that packet is dropped. Accordingly, the token count remains at 1. If this is the case, the bias token count value stored back in memory 110 is 1−1,000,001=−1,000,000.

For a second test case, again assume the size of the second packet corresponds to 1000 tokens. Further, assume that the token bucket is in-profile (because in-profile requires that the token count is >=0) and that packet length is subtracted from the current token count. Accordingly, the token count is now 1−1000=−999. In this case, the biased token count value stored back in memory 110 is −999−1,000,001=−1,001,000.

Now assume the first test case occurred and a third packet of length 1000 arrives at time T3=10 seconds. The current token count is calculated as −1,000,000+10,000,000,000=9,999,000,000, but because the maximum allowed token count is 1000, this saturates at 1000. The packet length is subtracted from the token count, and the biased token count to be stored back to memory is calculated as 0−10,000,000,000=−10 billion. This value is very large, especially since the space used in memory 110 to store the value is finite. For example, in one embodiment, the value may be represented by a 32 bit binary number that allows for storage of a number within the range −2 billion to +2 billion. Accordingly, the value of −9.999999999 billion may be too large due to some memory constraints. For this reason, the timer 112 is periodically refreshed to its starting point (T₀) at which time, the biased token count stored in memory is increased by the number of tokens accumulated during the refresh period. For demonstration of an exemplary refresh operation, consider the following example.

Assume, that the token bucket is periodically refreshed every second (i.e. refresh period is 1 second) and the rate R is 1 billion tokens/second. Also, assume an in-profile packet of size 1000 arrives at t=T₁ (1 millisecond). A second packet arrives at t=T₂=T₁+1 nanosecond. Further, let's assume that the second packet is out-of-profile and dropped. Accordingly, the token count remains at 1. At T₂, the biased token count value stored back in memory is 1−1,000,001=−1,000,000. Next, assume before the timer reaches 1 second, a third packet arrives at t=T₃=1 second−1 nanosecond.

At T₃, the token bucket administration apparatus 108 reads the stored biased token count value out from memory which is −1,000,000, where T₃=1 second−1 nanosecond=0.999999999 second or 999,999,999 nanoseconds. Therefore, 999,999,999 tokens have accumulated from T₀ to T₃ according to the rate R. This result is added to the biased token count to calculate the current token count as −1,000,000+999,999,999=998,999,999. Since this is greater than 1000, the actual token count saturates at 1000.

Now, assume that the size or length of the new packet corresponds to 1000 tokens. Further assume that the packet is in-profile and that packet length is subtracted from the token bucket. Therefore, after subtraction, the current actual token bucket count=0. The biased token count value to be stored back in memory 110, by token bucket administration apparatus 108, to represent the biased token count value is 0−999,999,999=−999,999,999.

Then, the timer reaches t=1 second, which means that it is time for a refresh of the token bucket. At time t=1 second, 1 billion tokens have accumulated according to rate R. For the refresh, 1 billion tokens are added to the biased token count: −999,999,999+1,000,000,000=1. Effectively, the biased token count stored back to memory is set to the actual token count which is equal to 1. The process of allocating tokens may then continue as before the refresh. At any particular instant, the calculated token bias (i.e., R×t) represents the amount of tokens accumulated since the last refresh operation on the token bucket.

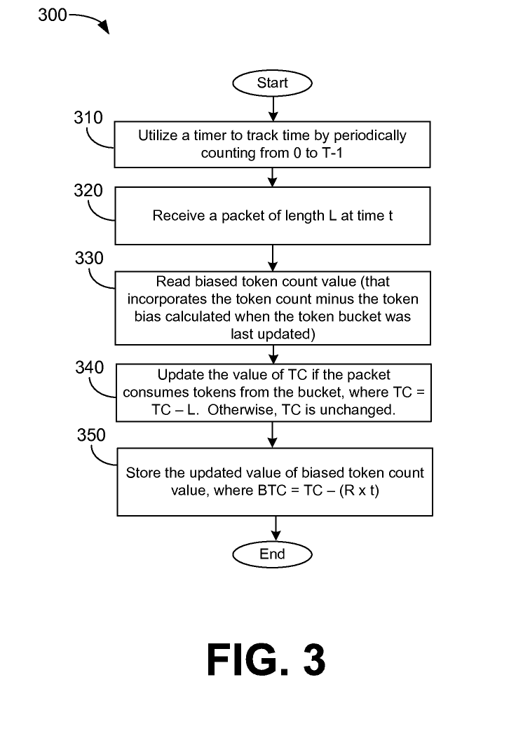

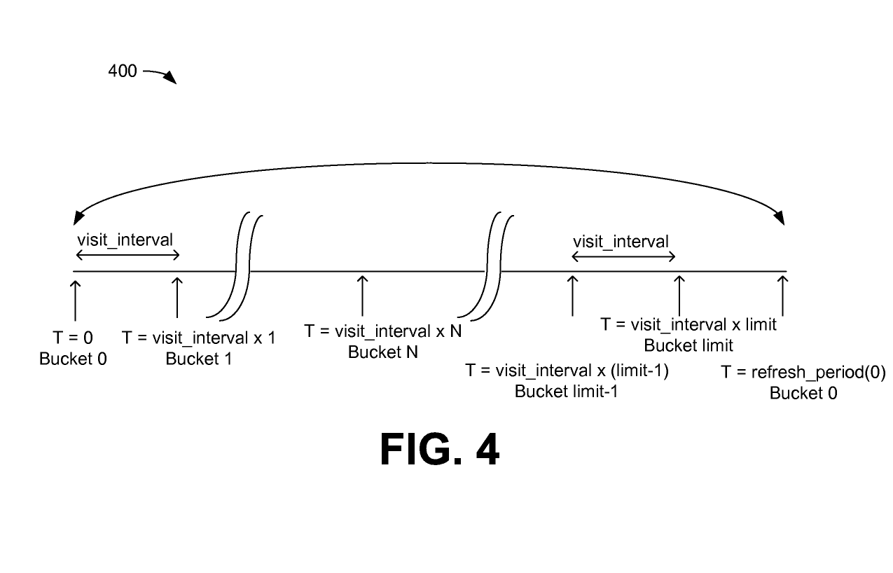

The foregoing illustrative, and non-limiting, examples show that token accounting processes of the present disclosure (see, e.g., flowcharts of FIG. 3 and FIG. 4) can be tailored to provide a granularity or smoothness of accounting for the tokens, as desired. Granularity may be selected in accordance with the chosen unit of time. Therefore, if the unit of time is in nanoseconds, tokens can be tracked in nanoseconds. In the foregoing examples, there is no restriction on how often the timer 112 is periodically refreshed.

The above examples described token account processes for a single token bucket. However, embodiments of the token bucket administration apparatus 108 are also responsible for administering token allocations for plural token buckets, each with independently configured rate (R) and burst size (BS) parameters. For instance, plural token bucket statuses may be stored in memory 110, where the memory contains plural memory entries (TB₁ . . . TB_{N}). Each entry may correspond to a single token bucket or a set of token buckets, as an example. A single logical operation may update a set of related token buckets atomically such that excess tokens overflow from one bucket within the set to another bucket within the set in a cascading fashion. Accordingly, token accumulation rate R of one of the buckets of the set, as described in the application, may be a committed information rate, excess information rate, and other described accumulation rates, in accordance with various token bucket arrangements.

In one such arrangement, the entire set of token buckets is operated on atomically at the same instant. For example, the biased token counts are read from memory 110, and the actual token counts are calculated based on the R and BS of each token bucket. If the maximum allowable tokens of a bucket is exceeded, the excess tokens may be added (i.e. cascaded) into another token bucket in the set in accordance with an exemplary embodiment. Accordingly, the packet length may be subtracted from a subset of the token buckets (e.g. based on the in-profile/out-of-profile status of each bucket). Finally, the biased token count is re-calculated for each bucket before storing them all back to memory 110. The periodic refresh occurs similarly.

Therefore, in various embodiments, a single bucket token meter, a dual bucket token meter, or other type of token meters may be implemented with the token bucket administration apparatus 108. Embodiments of the token bucket administration apparatus 108 support configurability in order to implement behaviors specified in RFC2697 (srTCM), RFC2698 (trTCM), RFC4115, and/or the Metro Ethernet Forum Ethernet Services Attributes Phase 1 document, all of which are incorporated herein in their entirety. Additional behaviors besides those discussed above may also be implemented in certain embodiments to control or police the flow of packets. Further, operation of the token bucket administration apparatus may also be extended to administer and manage other bucket algorithms, such as leaky bucket algorithms, among others, in accordance with the present disclosure.

For a refresh operation, the token bucket administration apparatus 108 is responsible for accounting for the token bucket statuses of each memory entry, in various embodiments. Therefore, a single token bucket administration apparatus 108 is configured to iterate through the sets of token buckets, processing each in sequence by reading the current value from memory, updating it, and writing it back to memory 110. It follows that the token bucket administration apparatus is capable of operating at a rate that is not directly tied to the token accumulation or information rate R of any single token bucket.

By recognizing that the state for each individual token bucket can effectively be represented in terms of a biased token count rather than by a token count and a separate explicit timestamp, embodiments are not limited in using a number of bits to store each token count and its timestamp, where each additional bit used to represent a timestamp is taken away from the bits used to represent the token count.

As an example, assume there are a million token buckets to manage and the refresh period is 1 second. Therefore, the token bucket administration apparatus 108 may be configured to handle a refresh for a different token bucket in each microsecond of time (i.e., 1 second divided by 1 million). Accordingly, each token bucket is indexed within a global calendar of time corresponding to the refresh period. For example, bucket 0 is handled at global time 0, bucket 1 is handled at global time 1 μs, bucket 2 is handled at global time 2 μs, bucket 1000 is handled at global time 1000 μs, and so on (assuming index starts at 0).

In this example, the length of the calendar is 1 second, and each entry of the calendar is separated by an increment of 1 μs denoted as a visit_interval. Further, a packet can arrive at any particular point in the calendar. The packet is associated with particular token bucket or set of token buckets which corresponds to a certain index or calendar entry. The token bucket administration apparatus 108 measures the time since the last refresh of that token bucket, where the global time of the last refresh within the calendar is the local starting point of the timing period of the token bucket.

Therefore, assume the calendar is broken up into 1 million sections or entries due to there being 1 million token buckets. At time t=0.5 second, a new packet arrives, where the packet is associated with the 250,000th token bucket out of 1 million. Index 250,000 corresponds to 250,000 microseconds (250 milliseconds) within the calendar (assuming the index starts at 1). For a current global time of 500,000 μs (or 0.5 seconds), the local starting point corresponds to a global time of 250,000 μs. Therefore, the local starting point is offset by 250,000 μs from the starting point of the global timer (i.e., visit_interval×250,000). In other words, for the token bucket at calendar index 250,000, the time since the last refresh for the token bucket is 500,000−250,000=250,000 μs (or 0.25 sec). A calendar representation is shown in FIG. 4 and discussed in additional detail at a later portion of this paper.

As mentioned previously, maintaining a large number of token buckets (e.g., 1M) with fine grained token accumulation is challenging. Using techniques of the present disclosure, an exemplary implementation of the token bucket administration apparatus 108 takes advantage of the instantaneous position of a token bucket in a refresh calendar to infer the incremental amount of received tokens on-the-fly as packets arrive for the token bucket. This solves the granularity problem while still allowing a relatively large bucket refresh period.

The token bucket administration apparatus 108 performs update operations for memory 110 in which plural token buckets are stored. Operations may involve updates for arrived packets or refresh operations at the close of the refresh period. Operations responding to packet arrivals may have priority over refresh operations. To keep track of pending refresh operations that are waiting to be performed by the token bucket administration apparatus 108, a head offset pointer or parameter is used to point to the next token bucket in a calendar that is due to be refreshed. Also, a tail offset pointer is used to point to the most recent token bucket in the calendar that is waiting to be refreshed. Therefore, the head and tail offset pointers keep track of refreshes that have been scheduled to happen but have not actually been performed yet.

Ideally, the tail offset pointer is equal to the head offset pointer (i.e., they point to the same calendar location), and there is no pending refresh that needs to be done. However, invariably, a packet arrives at some point in time, where the head offset pointer has moved past the tail offset pointer, signifying that a refresh operation has yet to be performed as scheduled. Therefore, when a packet arrives causing an instruction to be sent to the token bucket administration apparatus 108 requesting a new update for a token bucket, the head/tail offset pointers are reviewed to determine whether a refresh operation has been delayed and is still pending for the token bucket. For further demonstration, consider the following example.

Assume at time t=0, a refresh operation was scheduled to be performed for a token bucket, but the token bucket administration apparatus 108 was unable to access memory 110 at that time. Then, at time t=1 nanosecond, a new packet arrives for the token bucket. This is 1 nanosecond past the time a refresh operation was scheduled to be performed. Upon review of the head/tail offset pointers on the calendar, it is determined that the token bucket index (within the calendar) falls in range between the header and tail pointers. Therefore, instead of using 1 nanosecond as the measurement of time since the last refresh, the appropriate measurement is 1 second (“refresh period”)+1 nanosecond (or 1.00000001 seconds).

In one embodiment, the granularity of the bucket is generally 1 token per byte, but there are circumstances under which it is advantageous for a single token to represent a fraction of a byte (½, ¼, ⅛, etc.). To help shown a possible benefit of scaling, consider a system where a single token bucket administration apparatus 108 (i.e., one refresh calendar) handles multiple token buckets. The highest rate token bucket handled by the apparatus has a rate of 1 billion bytes per second, and therefore, due to the limited precision (in bits) of the biased token count representation, the refresh period must be no longer than 1 second. Another token bucket managed by the apparatus has a rate of 1.5 bytes per second. With a fixed granularity of 1 token per byte, it is not possible to exactly represent a rate of 1.5 bytes per second.

Therefore, in various embodiments, a scaling factor may be calculated as a function of the refresh period and the configured rate R. In an exemplary implementation, 16 bits are used in a normalized floating point representation of the rate R consisting of 5 bits of exponent and 11 bits of mantissa. R represents bytes per clock cycle and the clock cycle period is 1 nanosecond. For a given exponent, there are 2¹¹ or 2048 discrete different rates that can be represented within that exponent value.

However, given a fixed granularity of 1 token per byte, and given a refresh period length which is limited by the bit precision of the token buckets, it may be that the product R×T for a low-rate bucket is much less than 2048 tokens (or bytes). Since fractional tokens are discarded when refreshing a token bucket, this implies that the precision in expressing rates is not consistent over the range of exponent values. For example, imagine a single system with a refresh period of 1 second, containing at least 2 token buckets, where one has a rate of 1 billion bytes per second, and another with a rate of 1000 bytes per second. If the mantissa of the slower rate is increased by 1, this will result in a rate of 1000.48, which when the fractional part is discarded, does not effectively change the rate at all. It follows from this example that the tokens per refresh period must be at least 2048 in order to be able to express 2048 unique rates within a given exponent setting.

In general, if there are N bits of mantissa, it is desired to move the decimal point such that there are N bits to left of decimal point in the product R×refresh_period. This is because the fraction part of the product R×refresh_period is discarded during a refresh operation. The token bucket administration apparatus 108 can be configured to determine this on the fly, since it is a function of two things: 1) refresh period which is known; and 2) accumulation rate R of the token bucket which is known. For example, if the product R×refresh_period is 1024, the granularity is scaled to 1 token per half byte such that the R×refresh_period product is 2048. Now increasing or decreasing the mantissa by 1 will result in a different rate rather than the difference being discarded.

Note that rounding error can be eliminated entirely by configuring the refresh period parameter or value (“refresh_period”) to be a power-of-2 number of units of time. If this is the case, during the calculation of the periodic refresh tokens, the multiplication of the rate by the refresh_period is essentially a left shift. The scaling adjustment described above guarantees that there will be no discarded significant digits after the shift.

Depending on the application requirements, a specific hardware implementation may choose to instead scale the refresh_period as a function of each token bucket's token accumulation rate R rather than scaling the token bucket representation itself. This has the advantage of the token bucket's representation being consistent across the entire range of rates, and can also serve to make the scaling entirely transparent for a user perspective. The tradeoff is that processing latency may increase because the effective time delta since the last refresh cannot be calculated until the rate parameter is known.

As in the preceding example, if the R×refresh_period product is 1024, instead of changing the granularity of a token, the refresh period is scaled by 2× for this token bucket. An additional counter is maintained which increments once after every refresh period. This counter is used to differentiate between even calendar cycles and odd calendar cycles, and the token bucket is only refreshed on even calendar cycles. In other words, instead of adding 1024 tokens every refresh period, the refresh mechanism adds 2048 tokens every other refresh_period. This can be generalized to refreshing every 4, 8, 16, etc. calendar periods in accordance with scaling factors of 2, 3, 4, etc., respectively.

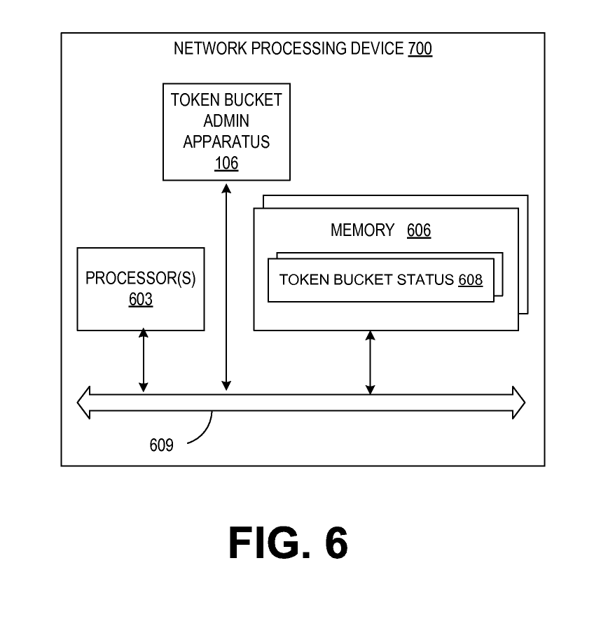

Referring now to FIG. 3, a flow chart is depicted describing a process 300 of accounting for tokens for a token bucket. The flow chart provides one example of the operation of a portion of the token bucket administration apparatus 108 according to various embodiments. It is understood that the flow chart of FIG. 3 provides merely an example of the many different types of functional arrangements that may be employed to implement the operation of the portion of the token bucket administration apparatus 108 as described herein. As an alternative, the flow chart of FIG. 3 may be viewed as depicting an example of operations or actions of a method implemented in a network processing device 600 (FIG. 6) according to one or more embodiments.

To begin, a timer 112 keeps track of time by periodically counting (310) from 0 to T−1. Here, the accumulation rate (R) is expressed in tokens per unit of time (e.g., clock cycle(s)), and a token bucket is refreshed with (R×T) tokens every time the timer reaches 0. Then, a packet of length L arrives and is received (320) at time t. A biased token count value (BTC) incorporating both the token count (TC) and the token bias measurement is read from (330) memory 110, where the current token count (TC) is calculated as TC=min {BS, BTC+(R×t)}. It is assumed that the maximum available token count for a bucket is BS. If the packet consumes tokens from the bucket, then TC=TC−L (at reference number 340). Also, the value of biased token count is updated (BTC=TC−(R×t)) and stored (at reference number 350). Note, that the reformulation avoids storing a separate timestamp for each token bucket. Instead, rather than explicitly representing the bucket's token count, the biased token count represents:

Token count at the time of the most recent refresh—

Tokens consumed by packets since the most recent refresh—

Tokens “lost” due to overflow since the most recent refresh.

Therefore, when a packet arrives, the biased token count value is converted to the actual token count by temporarily biasing it with the incremental number of tokens accumulated since the last refresh of the bucket and the time of the current packet arrival. Accordingly, in order to support multiple token buckets, each token bucket is assigned a specific position in a calendar which indicates the time where it is refreshed. Therefore, the time since the last refresh of the token bucket is represented by the distance between the arrival time of the packet t and the token bucket's position in the calendar.

For example, a first token bucket may occupy position 0 in the calendar. In this case, the time since the last refresh when a packet arrives at time t is simply t. Then, for a token bucket in the middle of a sequence or set, its calendar position may be at time T/2, where T is the size of the calendar. In this case, if the arrival time is greater than T/2, the distance is simply t−T/2. On the other hand, if the arrival time is less than T/2, the time has “rolled over” and the distance is T/2+t.

Reformulating the token bucket representation in this way affords much more flexibility in the range of rates that can be supported among independent token buckets that are all refreshed according to the same calendar. Compared to conventional techniques, the simplicity and flexibility of configuration, accuracy of metering behavior relative to the ideal, and memory bandwidth efficiency are all increased.

As an aid, FIG. 4 provides a visual representation for the refresh calendar segment 400, to help illustrate the above actions. In the illustration, refresh_period may be defined as follows, where parameter visit_interval defines a length of time between calendar entries:

refresh_period=visit_interval×N,

where N is the total number of token buckets.

Therefore, during a periodic refresh, the amount of bytes added to each bucket (“added_bytes”) is calculated by multiplying the rate (R) by the refresh_period:

added_bytes=refresh_period×rate R.

If this product has leftover fractional bits, the value is rounded up or down to the nearest integer to minimize error, in one embodiment.

These parameters or state variables described above are updated automatically with respect to the timer in accordance with embodiments of the present disclosure. In particular, the timer 112, head offset pointer, and tail offset pointer of the associated calendar segment are sampled in order to determine if there is a pending refresh request for the token bucket in question. Such information is important to know exactly how much time has elapsed since the last periodic refresh to a token bucket.

Therefore, embodiments of the present disclosure provide a unique hardware implementation for a token bucket administration apparatus 108, which allows accurate tracking of a token bucket's token count relative to the arrival time of a packet, where the granularity of measurement for arrival time of a packet may be a single clock cycle, in one embodiment. Although tokens are periodically added to the token bucket, the length of the refresh period can be extended to an arbitrarily long period of time (only limited by the precision of the token bucket representation) without affecting the accuracy of the instantaneous token count measure at the arrival time of a packet (which may be at some intermediate time within the refresh period). This allows for saving memory bandwidth and improving accuracy. It also makes it relatively straightforward to represent token bucket rates as floating-point values (configurable to rates ranging from the kilobit per second to 100s of gigabits per second range) in certain embodiments. As a result, a large number of independent token buckets can be supported within a network processing device 100 with substantially little error and supportive of a range of burst sizes which are unconstrained by the rate of the associated token bucket(s). As a non-limiting example, it is also possible for token buckets with rates in the kilobit range to coexist with token buckets with rates in the 100 gigabit range with few compromises in accuracy and configurability compared to previous implementations in accordance with the present disclosure.

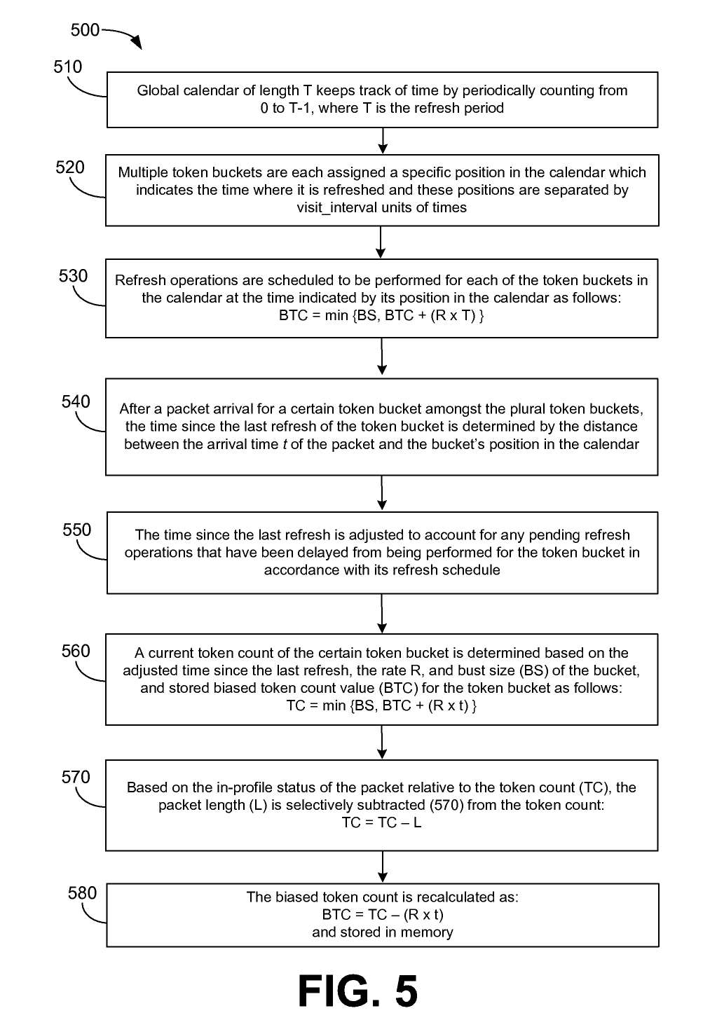

Referring now to FIG. 5, a flow chart is depicted describing a process 500 of tracking time for plural token buckets. The flow chart provides one example of the operation of a portion of the token bucket administration apparatus 108 according to various embodiments. It is understood that the flow chart of FIG. 5 provides merely an example of the many different types of functional arrangements that may be employed to implement the operation of the portion of the token bucket administration apparatus 108 as described herein. As an alternative, the flow chart of FIG. 5 may be viewed as depicting an example of operations or actions of a method implemented in a network processing device 600 (FIG. 6) according to one or more embodiments.

To begin, a timer 112 user a global calendar of length T keeps track of time by periodically counting (510) from 0 to T−1. Here, the token accumulation rate R is expressed in tokens per unit of time (e.g., clock cycle(s)), and a token bucket is refreshed with (R×T) tokens once per calendar period. Each token bucket may have an independent accumulation rate Rᵢ. In order to support multiple token buckets, each token bucket is assigned (520) a specific position in the calendar which indicates the time where it is refreshed and these positions are separated by visit_interval units of times. Therefore, refresh operations are scheduled to be performed (530) for each of the token buckets in the calendar based on its position in the calendar as follows: BTC=min {BS, BTC+(R×T)}. Further, after a packet arrives for a certain token bucket amongst the plural token buckets, the time since the last refresh of the token bucket is determined (540) by the distance between the arrival time of the packet t and the bucket's position in the calendar. Further, the time since the last refresh is adjusted (550) to account for any pending refresh operations that have been delayed from being performed for the token bucket in accordance with its refresh schedule. Then, a current token count of the certain token bucket is determined (560) based on the adjusted time since the last refresh, the rate R, and bust size (BS) of the bucket, and stored biased token count value for the token bucket as follows: TC=min {BS, BTC+(R×t)}. Based on the in-profile/out-of-profile status of the packet relative to the token count (TC), the packet length (L) may (or may not) be subtracted (570) from the token count: TC=TC−L. Next, the biased token count is recalculated as: BTC=TC−(R×t), and stored (580) in memory 110.

Implementations of the various techniques described herein may be implemented in digital electronic circuitry, or in computer hardware, firmware, software, or in combinations of them. FIG. 6 is a schematic block diagram of an exemplary network processing device 600, 100 (FIG. 1) that is equipped with embodiments of the token bucket administration apparatus 108 according to the present disclosure. The network processing device 600 includes a processor 603 and a memory 606, 110 (FIG. 1) which are coupled to a local interface 609. The network processing device 600 may comprise, for example, at least one computing device or like device. The network processing device 600 may be or select components may be embedded on a chip as part of an on-chip network, such as one embedded in a system on a chip (SoC) for a communication system. The local interface 609 may comprise, for example, a data bus with an accompanying address/control bus or other bus structure as can be appreciated.

The network processing device 600 may be implemented as a board level product, as a single chip, application specific integrated circuit (ASIC), and so on. It is understood that there may be other systems that are stored in the memory 606 and are executable by the processor 603 as can be appreciated. A number of software components, such as token bucket status 608, traffic profiles, etc., are stored in the memory 606 and are executable by the processor 603. In this respect, the term “executable” means a program file that is in a form that can ultimately be run by the processor 603. It is also understood that some components, such as the token bucket administration apparatus 108 and/or related components, may be implemented as firmware or hardware components, in some embodiments.

Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), and/or other memory components, or a combination of any two or more of these memory components. In addition, the RAM may comprise, for example, static random access memory (SRAM), dynamic random access memory (DRAM), or magnetic random access memory (MRAM) and other such devices.

Also, the processor 603 may represent multiple processors 603 and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction. In one embodiment, the processor 603 and memory 606 may correspond to a system-on-a-chip.

Although portions of the network processing device 600 described herein may be embodied in software or code executed by general purpose hardware as discussed above, as an alternative, the same may also be embodied in dedicated hardware or a combination of software/general purpose hardware and dedicated hardware. If embodied in dedicated hardware, each component may be implemented as a circuit or state machine that employs any one of or a combination of a number of technologies. These technologies may include, but are not limited to, discrete logic circuits having logic gates for implementing various logic functions upon an application of one or more data signals, ASICs having appropriate logic gates, or other components, etc. Such technologies are generally well known by those skilled in the art and, consequently, are not described in detail herein.

Similarly, components of the network processing device 600, 100 (FIG. 1), in combination with operational instructions stored in memory, may be, but is not limited to being, enabled to execute receiver functions and/or transmitter functions, respectively. The receiver functions may comprise, but are not limited to, demodulation, constellation demapping, decoding, and/or descrambling. The transmitter functions may comprise, but are not limited to, scrambling, encoding, constellation mapping, and modulation. The receiver and the transmitter components, respectively, may be implemented using a shared processing device, individual processing devices, or a plurality of processing devices, for example, a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

The flow charts of FIGS. 3 and 5 show the functionality and operation of an implementation of portions of the token bucket administration apparatus 108. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flow charts of FIGS. 3 and 5 show a specific order of execution, it is understood that the order of execution may differ from that which is depicted. For example, the order of execution of two or more blocks may be scrambled relative to the order shown. Also, two or more blocks shown in succession in FIG. 3 or FIG. 5 may be executed concurrently or with partial concurrence. Further, in some embodiments, one or more of the blocks shown in FIG. 3 or FIG. 5 may be skipped or omitted. It is understood that all such variations are within the scope of the present disclosure.

Also, any logic or application described herein that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, communicate, propagate, or maintain the logic or application described herein for use by or in connection with the instruction execution system.

The computer-readable medium can comprise any one of many physical media such as, for example, magnetic, optical, or semiconductor media and may include electronic, electromagnetic, infrared, or, or propagation media. More specific examples of a suitable computer-readable medium would include, but are not limited to, random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### APPENDIX

The following is a nonlimiting example of pseudocode that can be employed to implement an embodiment of the token bucket administration apparatus 108; and additional notes.

### Pseudocode:

Definition of terms and procedures:
TB: array of token bucket sets
TB[n]: n^{th} token bucket set in array
N: number of token bucket sets in array
TB[n][m]: m^{th} token bucket in n^{th} set
TB[n][m].btc: biased token count (fixed point)
TB[n][m].r: rate (normalized floating point)
r.e: exponent of rate
r.m: mantissa of rate
M: number of mantissa bits for this implementation
TB[n][m].bs: burst size
TB[n][m].cf: cascade flag (when set, excess from bucket (m−1) cascades into bucket m)
tc: token count
tb: token bias
tc.scale: scale factor applied to token count (e.g. packet length (L) should be left shifted by scale). ONLY USED IF SCALE_REFRESH=0 FOR THIS IMPLEMENTATION, OTHERWISE scale=0
refresh_period: there are refresh_period cycles between 2 consecutive scheduled refreshes of the same token bucket set TB[n]
global_time: counts from 0 to refresh_period-1 and repeats
refresh_cycles: increments when global_time “wraps” from refresh_period-1 to 0
visit_interval: time between scheduled refresh for TB[n] and TB[n+1]
visit_time: counts from 0 to visit_interal-1 and repeats (refresh is scheduled when it rolls over)
scheduled_refreshes_count: number of refreshes that have been scheduled but not yet executed
scheduled_refreshes_head: index of next token bucket set to be refreshed
scheduled_refreshes_tail: index of token bucket set for which refresh has been scheduled most recently
scale get_scale(r): calculates scaling factor as a function of rate (R) and refresh_period
BOOL is_refresh_scheduled(n): boolean function returns TRUE if refresh for TB[n] has been scheduled but not yet performed (i.e. n is between scheduled_refreshes_head and scheduled_refreshes_tail inclusive), and FALSE otherwise.
tb[ ] get_tb(n): returns set of token biases (tb[ ]) for TB[n], calculated as function of r, bs, and btc of each TB[n][m], as well as global_time, refresh_cycles, refresh_period
tc[ ] get_tc(n): returns set of tc (each with an optional independent scale: tc.scale) as function of btc, and token bias for each TB[n][ ]
tc[ ] get_tc(n, tb[ ]): returns set of tc (each with an optional independent scale: tc.scale) as function of set of token biases (tb[ ]) and cf (get_tc( ) is overloaded depending on arguments). Token biases are added to TB[n][m].btc with cascading from bucket to bucket according to TB[n][m].cf
set_btc(n, tc[ ]): set TB[n][ ].btc as function of tc[ ] and token biases for each TB[n][ ]
set_btc(n, tc[ ], tb[ ]): set TB[n][ ].btc by subtracting tb[m] from tc[m] for each TB[n][m] in set
refresh_scheduling_process( ) independent background process increments global_time and visit_time every time unit (e.g. clock cycle), increments refresh_cycles when global_time “wraps” from refresh_period-1 to 0, schedules a refresh when global_time==visit_interval*n (using visit_time)
refresh( ) executed opportunistically when scheduled_refreshes_count>0. refresh TB[n][ ].btc for all token buckets in set based on r, bs, cf, and refresh_period. where n is token bucket set indicated by scheduled_refreshes_head. For some implementations, this happens immediately when the refresh is scheduled. For other implementations, there may be a delay of up to refresh_period cycles between when a refresh is scheduled for a particular TB[n] and when it is actually executed by refresh( )
SCALE_REFRESH: indicates whether a particular implementation scales tokens (i.e. moves the fixed point of TB[n][m].btc) or scales the refresh (i.e. (refresh_period<<scale*r) tokens are added every 2̂scale refresh cycles)

Detailed Descriptions of Procedures:

scale get_scale(r) {

| if (r*refresh_period < 2\hat{ }M) { | |
|---|---|
| | scale = M − floor(log2(r*refresh_period)); |
| } | |
| else { | |
| | scale = 0; |
| } | |
| // Note that this calculation can be simplified by rounding down | |
| // log2(refresh_period) in place of refresh_period, allowing addition | |
| // of exponents rather than a multiply. This may result in a | |
| // scaling factor 1 greater than absolutely necessary under some | |
| // circumstances, but it saves a multiply. floor(log2(refresh_period)) | |
| // can be calculated easily in digital logic by finding the index of | |
| // most significent bit set to 1: | |
| // if (r.e+floor(log2(refresh_period)) < M) | |
| // | scale = M − r.e + floor(log2(refresh_period)); |
| // else | |
| // | scale = 0; |

}
BOOL is_refresh_scheduled(n) {

if (scheduled_refreshes.count != 0) {

if (scheduled_refreshes.tail < scheduled_refreshes.head) {

// special case where tail has wrapped but head has not
if (scheduled_refreshes.tail < n <
scheduled_refreshes.head)

return FALSE;

else

return TRUE;

}
else {

// for normal case, refresh is scheduled if n is between head
// and tail inclusive
if (scheduled_refreshes.head <= n <=
scheduled_refreshes.tail)

return TRUE;

else

return FALSE;

}

}
else

return FALSE;

}
tb[ ] get_tb(n) {

foreach (TB[n][m]) { // m iterates over all token buckets in set TB[n]

refresh_time = visit_interval * n;
// refresh_time is value of global_time between 0 and
// refresh_period−1 when refresh is scheduled for TB[n]
if (SCALE_REFRESH) {

refresh_scale = get_scale(TB[n][m].r);
token_scale = 0;

}
else {

refresh_scale = 0;
token_scale = get_scale(TB[n][m].r);

}
scaled_global_time = (((1<<refresh_scale)−1)&refresh_{—}
cycles) *

refresh_period + global_time;

```
// scaled_global_time handles the case where the refresh is
scaled
time_delta = scaled_global_time − refresh_time;
if ((scaled_global_time < refresh_time) ||
  (is_refresh_scheduled(n) && (time_delta < refresh_{—}
  period)) {
```

// either last refresh was in previous scaled refresh cycle
// OR
// refresh was recently scheduled but not executed yet
time_delta += refresh_period<<refresh_scale;

}
scaled_rate.m = TB[n][m].r.m;
scaled_rate.e = TB[n][m].r.e << token_scale;
tb[m] = scaled_rate * time_delta;

}

}
tc[ ] get_tc(n) {

tb[ ] = get_tb(n);
tc[ ] = get_tc(n, tb[ ]);

}
tc[ ] get_tc(n, tb[ ]) {

excess = 0;
excess.scale = 0;
foreach (TB[n][m]) { // m iterates over all token buckets in set TB[n]

if (SCALE_REFRESH)

tc[m].scale = 0;

else

tc[m].scale = get_scale(TB[n][m].r);

// align scale of excess with TB[n][m].scale
if (excess.scale > TB[n][m].scale)

excess = excess >> (excess.scale − TB[n][m].scale);

else if (excess.scale < TB[n][m].scale)

excess = excess << (TB[n][m].scale − excess.scale);

tokens_to_add = tb[m];
if (TB[n][m].cf) {

// only add excess tokens if cf=1
tokens_to_add += excess;

}
// bs should be scaled just like tb is scaled (see get_tb(n))
scaled_bs = TB[n][m].bs << tc[m].scale;
if ((TB[n][m].btc + tokens_to_add) > scaled_bs) {

// token bucket is overflowing
tc[m] = TB[n][m].bs;
excess = (TB[n][m].btc + tokens_to_add) − scaled_bs;

}
else {

// token bucket is NOT overflowing
tc[m] = TB[n][m].btc + tokens_to_add;
excess = 0;

}
excess.scale = tc[m].scale;

}

}
set_btc(n, tc[ ]) {

tb[ ] = get_tb(n);
set_btc(n, tc[ ], tb[ ]);

}
set_btc(n, tc[ ], tb[ ]) {

foreach (TB[n][m]) { // m iterates over all token buckets in set TB[n]

TB[n][m].btc = tc[m] + tb[m];

}

}
refresh( ) {

n = scheduled_refreshes_head;
if (scheduled_refreshed_head == (N−1))

scheduled_refreshes_head = 0;

else

scheduled_refreshes_head++;

scheduled_refreshes_count−−;
tb[ ] = get_tb(n);
tc[ ] = get_tc(n, tb[ ]);
foreach (TB[n][m]) { // m iterates over all token buckets in set TB[n]

if (SCALE_REFRESH) {

refresh_scale = get_scale(TB[n][m].r);
token_scale = 0;

}
else {

refresh_scale = 0;
token_scale = get_scale(TB[n][m].r);

}
if ((((1<<refresh_scale)−1)&refresh_cycles) == 0) {

// perform refresh
tb[m] += ((TB[n][m].r <<

token_scale)*refresh_period)<<refresh_scale;
}

}
set_btc(n, tc[ ], tb[ ]);

}
refresh_scheduling_process( ) {

global_time = 0;
refresh_cycles = 0;
visit_timer = 0;
n = 0;
scheduled_refreshed_count = 1;
scheduled_refreshes_head = 0;
scheduled_refreshes_tail = 0;
repeat_for_each_clock {

if (visit_timer == (visit_interval−1)) {

visit_timer = 0;
scheduled_refreshes_count++;
if (scheduled_refreshes_tail == (N−1))

scheduled_refreshes_tail = 0;

else

scheduled_refreshes_tail++;

}
else

visit_timer++;

if (global_time == (refresh_period−1)) {

global_time = 0;
refresh_cycles++;

}
else

global_time++;

}

}

As an example, these fundamental operations may be used to implement a policer as follows:
1. packet arrives with length L
2. packet is associated with a flow n
3. tb[ ]=get_tb(n)
4. tc[ ]=get_tc(n, tb[ ])
5. examine each of tc[m] and conditionally subtract L from tc[m], depending on specific policer standard (e.g. RFC2697, RFC2698, etc.). Note that published standards are limited to 2 token buckets per set, but this disclosure is generalized to an arbitrary number of token buckets per set.
6. set_btc(n, tc[ ], tb[ ]).

As another example, these fundamental operations may be used to implement a packet scheduler as follows:
1. scheduler executes tc[ ]=get_tc(n) for the token bucket set associated with each packet queue, where each queue is associated with a different n.
2. scheduler examines set of tc[ ] for each queue, and uses this information to inform a scheduling decision. Each queue may have several token buckets associated with it (e.g. shaper defining maximum rate not to be exceeded, and/or creditor defining minimum guaranteed rate).
3. After dequeuing bytes from the selected queue, designated selected_n, the schedule subtracts that number of bytes from each tc[m] of the associated queue.
4. set_btc(selected_n, tc[ ]).

Additional notes: TB[n][m].btc may be encoded as a fixed-point number such that the maximum value (i.e. all 1s in binary representation) represents a full bucket (i.e. biased token count of TB[n][m].BS). This is because a value of tc or btc greater than BS is NEVER allowed. It allows the full range of the fixed-point representation to be utilized, which maximizes the allowable refresh_period, thus minimizing the required frequency of refresh updates.

Additional notes: The per-token-bucket parameters including but not limited to TB[n][m].BS, TB[n][m].r, and TB[n][m].cf, may be stored on a per-token-bucket basis (i.e., in a data structure in memory along with each TB[n][m].btc). Alternatively, if the total number of discrete parameter settings is much less than the total number of token buckets N, the parameters may be stored in a separate data structure array (i.e. a profile array) with a number of entries much less than N. Then, a simple pointer to the parameter data structure is stored with TB[n][m].btc, which may save memory space in the array of token bucket sets.

Therefore, having thus described various embodiments, at least the following is claimed:

1. A network processing system comprising:
memory; and
a token bucket administration apparatus configured to iterate through a plurality of token buckets assigned to specific positions within a calendar segment and process each token bucket in sequence by reading a current token bucket status from the memory for the token bucket, updating the token bucket status, and writing the updated token bucket status back to the memory.

2. The system of claim 1, wherein the token bucket administration apparatus operates at a rate independent from a token accumulation rate of the token bucket.

3. The system of claim 2, wherein the token bucket administration apparatus scales a refresh period of a token bucket as a function of the token accumulation rate of the token bucket or scales a token bucket representation as a function of the refresh period and the token accumulation rate of the token bucket.

4. The system of claim 1, wherein the token bucket is part of a dual token bucket arrangement.

5. The system of claim 1, wherein the current token bucket status is updated responsive to a packet for transmission being received.

6. The system of claim 1, wherein the token bucket administration apparatus computes a state for each token bucket in terms of a biased token count, wherein the biased token count incorporates a token count value of the token bucket and a token bias value at time of last update of the state of the token bucket.

7. The system of claim 6, wherein the token bucket administration apparatus determines a head offset pointer indicating an offset of a next token bucket that is to be refreshed; and a tail offset pointer that is an offset of a last token bucket for which refresh is requested and pending that are stored in the memory.

8. The system of claim 7, wherein the token bucket administration apparatus is configured to account for any pending refresh operations that have been delayed from being performed for the token bucket in accordance with a refresh schedule of the calendar segment.

9. A method of allocating tokens for a token bucket comprising:
receiving indication of an arrival of a packet of length L at time t, where 0≦t≦T−1;
retrieving a biased token count value from memory for the token bucket, wherein the biased token count value incorporates a token count value of the token bucket and a token bias value at time of last update of the token bucket;
determining an updated token count value for the token bucket by adding the token bias value to the retrieved biased token count value, wherein the token bias value represents a number of tokens that are accumulated at the token bucket over time from 0 to time t;
further updating the token count value of the token bucket to account for transmission of the packet if the packet is authorized to be transmitted;
updating the biased token count value by subtracting the token bias value from a last updated token count value; and
storing the updated biased token count value for the token bucket.

10. The method of claim 9, wherein the packet is authorized to be transmitted when the packet is determined to be in-policy with network rules.

11. The method of claim 9, further comprising scaling a representation of the token bias value when the token bias value contains a fractional component.

12. The method of claim 9, where a granularity of measurement for arrival time of the packet is a single clock cycle.

13. The method of claim 9, wherein the token bias value is determined by multiplying a token accumulation rate in which tokens are accumulated by a time period measured since a last refresh of a timer of the token bucket.

14. The method of claim 9, further comprising:
tracking time using a global calendar of length T having positions for a plurality of token buckets, wherein the plurality of token buckets includes the token bucket, wherein a refresh is periodically scheduled to be performed for each of the plurality of token buckets within a period of length T; and
allocating tokens for each of the plurality of token buckets using the global calendar by using a position within the global calendar for a certain token bucket to determine an amount of tokens that have been received for the certain token bucket as a new packet arrives for the certain token bucket.

15. The method of claim 14, further comprising performing a refresh operation for a respective one of the plurality of token buckets in the global calendar based on a respective position of the respective one of the plurality of token buckets in the global calendar.

16. The method of claim 14, wherein the token bias value is determined by multiplying a token accumulation rate in which tokens are accumulated by a time period measured since a last refresh of the token bucket, wherein after the arrival of the packet for the token bucket amongst the plurality of token buckets, the time since the last refresh of the token bucket comprises a distance between an arrival time t of the packet and the position of the token bucket in the global calendar.

17. The method of claim 16, wherein the time since the last refresh is updated to account for any pending refresh operations that have been delayed from being performed for the token bucket in accordance with a refresh schedule of the global calendar.

18. The method of claim 9, wherein the token bucket is part of a dual token bucket arrangement.

19. A non-transitory computer readable medium having processor instructions for allocating tokens for a token bucket, that when executed by a hardware processor, causes the processor to:
receive indication of an arrival of a packet of length L at time t, where 0≦t≦T−1;
retrieve a biased token count value from memory for the token bucket, wherein the biased token count value incorporates a token count value of the token bucket and a token bias value at time of last update of the token bucket;
determine an updated token count value for the token bucket by adding the token bias value to the retrieved biased token count value, wherein the token bias value represents a number of tokens that are accumulated at the token bucket over time from 0 to time t;
further update the token count value of the token bucket to account for transmission of the packet if the packet is authorized to be transmitted;
update the biased token count value by subtracting the token bias value from a last updated token count value; and
store the updated biased token count value for the token bucket.

20. The medium of claim 19, the processor instructions further causing the processor to:
maintain a global calendar of length T having positions for a plurality of token buckets, wherein the plurality of token buckets includes the token bucket, wherein a refresh is periodically scheduled to be performed for each of the plurality of token buckets within a period of length T; and
allocating tokens for each of the plurality of token buckets using the global calendar by using a position within the global calendar for a certain token bucket to determine an amount of tokens that have been received for the certain token bucket as a new packet arrives for the certain token bucket.
